(19) United States
(12) Patent Application Publication
(10) Pub. No.: US 2009/0255444 A1
(43) Pub. Date: Oct. 15, 2009

(54) METHOD FOR CAPTURING CO2 PRODUCED BY CEMENT PLANTS BY USING THE CALCIUM CYCLE

(76) Inventor: Enrique Ramon Martinez Vera, Nuevo Leon (MX)

Correspondence Address: YOUNG & THOMPSON, 209 Madison Street, Suite 500, ALEXANDRIA, VA, 22314, US

(21) Appl. No.: 12/101,525

(22) Filed: Apr. 11, 2008

(51) Int. Cl. C04B 7/45

(52) U.S. Cl. 106/744

(57) ABSTRACT

A method for capturing CO₂ produced by cement plants by using the calcium cycle method comprising the integration of the process known as calcium cycle to the cement plant by using the cement plant raw materials and sub products in the calcium cycle plant and by using the calcium cycle plant raw materials sub products and residual energy in the cement plant

### BACKGROUND OF THE INVENTION

A. Field of the Invention

The present invention is related to methods for capturing the CO₂ produced by cement production plants, and more particularly with a method for capturing CO₂ produced by cement production plants by integrating the process known as calcium cycle to the cement plant.

B. Description of the Related Art

The atmospheric pollution in one of the most serious problems caused by the general industry and has a great impact in our planet's ecosystem. Said problem is mostly caused by the CO₂ emissions, which is a well know cause of the global warming.

Specifically, the cement production plants release huge quantities of CO₂ to the atmosphere as a result of the combustion of fuels used to heat the kilns where the transformation of limestone, clay, and iron ore which is generally called “raw meal”, into a cementitious material called clinker which is subsequently transformed into cement.

In order to carry out said transformation, the following steps must be performed: preheating the raw meal; calcining the raw meal in which the CO₂ is removed from the limestone and finally, submit the material to a clinkerization process for obtaining the clinker.

Each step produces CO₂ intensively in accordance with the following: in the first and third steps, the CO₂ is produced by the combustion of fossil fuels and/or alternative fuels such as tires, industrial waste, wood chips, etc. used to generate the heat necessary for the preheating step and for the clinkerization of the raw mill, an in the second step the CO₂ is produced by the calcining of limestone.

The chemical reactions producing CO₂ which are carried out inside a cement kiln are the following:

Carbon combustion contained in the fuels:

C+O₂→CO₂

Calcium carbonate calcining contained in the limestone:

CaCO₃→CaO+CO₂

In a cement kiln, approximately, the 65% of the CO₂ is produced by calcination processes; therefore, cement kilns are known to be very intensive CO₂ producers.

In view of the devastating effects caused by the atmospheric pollution in our planet, the most evident being the global warming, it is necessary to found methods for capturing and eventually sequester the CO₂. Said operation is also called carbon sequestration, in which the CO₂ is captured before contacting the atmosphere.

In view of the above referred necessities, the applicant developed a method for capturing CO₂ comprising the integration of the process known as calcium cycle to a cement plant in order to totally capture the CO₂ produced by said cement plant and simultaneously raising the productivity of the cement plant The above referred integration is carried out by using the cement plant raw materials and sub products in the calcium cycle plant and by using the calcium cycle plant sub products and residual energy in the cement plant.

The advantages of the synergy between the calcium cycle process and a cement production plant are very important, since in first place it is achieved the capture of CO₂ produced by the cement plant, in second place the raw materials of the cement plant can be used as a make up in the calcium cycle process and in third place, the energy produced by the exothermic reactions of the calcium cycle process can be used for producing steam for moving an electrical generator for producing electricity which may be used for covering the needs of the cement production plant.

### SUMMARY OF THE INVENTION

It is therefore a main objet of the present invention to provide a method for capturing CO₂ produced by cement production plants, comprising the integration of the process known as calcium cycle to the cement plant.

It is another main object of the present invention to provide a method of the above referred nature in which the raw materials and sub products of the cement plant are used by the calcium cycle and vice versa, thus raising the productivity of the cement plant.

It is a further object of the present invention to provide a method of the above referred nature in which the energy produced by the exothermic reactions of the calcium cycle process can be used for producing steam for moving an electrical generator for producing electricity which may be used for covering the needs of the cement production plant.

These and other objects and advantages of the method for capturing CO₂ produced by cement plants by using the calcium cycle the present invention will become apparent to those persons having an ordinary skill in the art, from the following detailed description of the embodiments of the invention which will be made with reference to the accompanying drawings

### BRIEF DESCRIPTION OF THE DRAWINGS

FIG. 1 is a scheme of a cement plant working in accordance with a first embodiment of the method of the present invention.

FIG. 2 is a scheme of a cement plant working in accordance with a second embodiment of the method of the present invention.

FIG. 3 is a scheme of a cement plant working in accordance with a third embodiment of the method of the present invention.

### DETAILED DESCRIPTION OF THE INVENTION

The method for capturing CO₂ produced by the kilns of a cement production plant using the calcium cycle of the present invention, will now be described making reference to a common cement production plant and to its common production method, to the process known in the state of the art known as calcium cycle and to the accompanying drawings.

### Conventional Process for the Production of Cement.

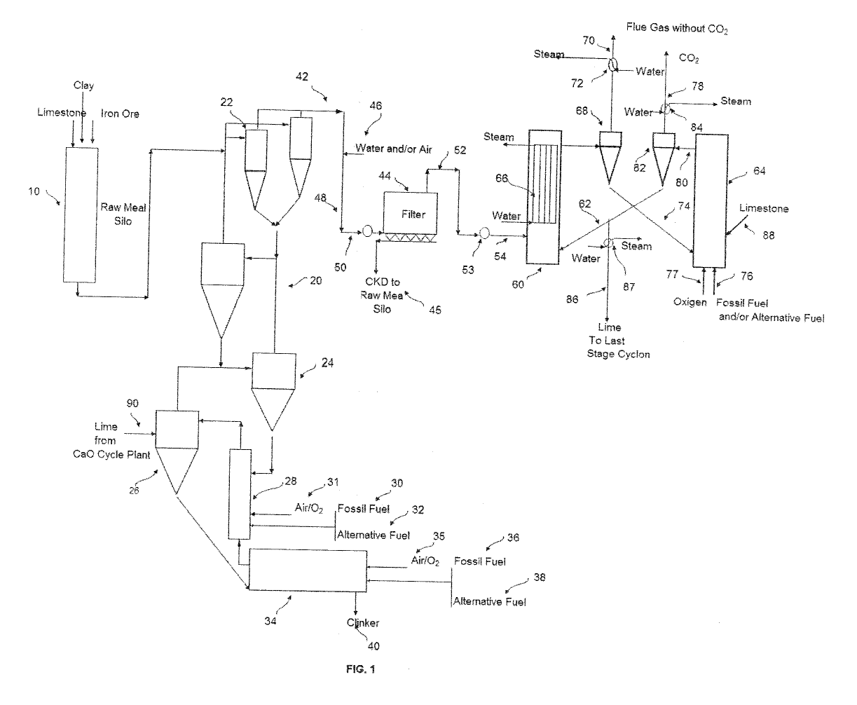

Referring to FIG. 1, the conventional method for the production of cement begins with the grinding of the raw materials comprising limestone, clay, and iron ore. Those raw materials are finely grinded and feed to a homogenization silo in the proportions required for the production of cement.

Once the raw material is finely grinded and homogenized, it is called raw meal, which is feed to the pre-heating section 20 of a cement kiln. Said section which is called pre-heater comprises typically a series of three to six interconnected cyclones.

The raw meal is feed to the entrance of the first cyclone 22 and flows downward aided by the gravity countercurrently to an upstream hot combustion gas current in order to preheat the raw meal and complete the first step in the production of the clinker.

The calciner 28 is located between the penultimate 24 and the last 26 cyclone, in which it is carried approximately a 90% of the limestone calcination reaction. The calcination is an endothermic reaction in which the heat is provided by the combustion of a fossil fuel 30 and/or an alternative fuel 32 in the presence of air and/or oxygen 31 which is feed to the base of the calciner 28. Said fuel may be in a solid form such as coal and petroleum coke, liquid such as fuel oils or gaseous such as natural gas. A part of said energy may be alternatively provided by alternative fuels such as tires, wood chins, industrial waste, etc.

Inside the calciner 28 it is carried out the second step in the production of clinker at a typical operation temperature of between 850 and 900° C.

The decarbonated raw meal is then feed to the last cyclone and then to an end of the rotary kiln 24 in which, it is carried out the clinkerization process, which is the last step for the production of the clinker.

The clinkerization process is carried out at a temperature of between 1500 and 1600° C., and the required energy is provided by the combustion of a solid, liquid or gaseous fuel or mixtures thereof in the presence of air and/or oxygen 35, including alternative fuels comprising the same alternative fuels previously described for the calciner 34. Said fuels are feed to the rotary kiln at the opposite end in which the decarbonated raw meal is feed.

The clinker 40 produced in the rotary kiln is cooled and feed to a mill in which it is mixed with gypsum and transformed into cement

### Emissions of the Conventional Process for the Production of Cement.

The flue gases from the calciner 28, and from the rotary kiln 34 , which includes the CO₂ produced by calcinations, flow upward countercurrently to a downward stream of raw meal. The gases that exit from the first cyclone 22 have a temperature of between 250 to 350° C. Said gases have high dust content, and therefore it is necessary to pass the gases trough a filter 44 in order to remove the dust. Said dust is known as Cement Kiln Dust (CKD) 45. In order to protect the filtering elements of filter 44, it is necessary to cool the gases to a temperature of less than 300° C. Said cooling is carried out by water or air injection 46. The cooled gases 48 flow to an induced draft fan (IDF) 50 which provides the necessary energy to the gases for flowing through the kiln 34 and the cyclones of pre-heater 20.

Normally the cooled and cleaned gases 52 exiting from the filter 44 are sent to a stack (not shown) and liberated to the atmosphere. Said gases have a content of between 15 to 30% of CO₂ depending on the type of fuels used in the cement process

The CKD 45 collected from the filter 44 is recycled to a raw meal silo 10. The recycled amount of CKD is of between 5 to 10% of the total amount of raw meal feed to the kiln. Said gases contain between 15 to 30% of CO₂ depending on the fuels used in the cement process.

Adaptation of the Calcium Cycle to the Cement Production Plant

In accordance with the above, the method of the present invention comprises connecting to the cement plant, a calcium cycle plant for capturing the CO₂ by feeding the combustion gases 52 exiting from the filter 44 by means of a forced draft fan 53 for producing a stream which is feed to a lower end of a first fluidized bed reactor 60 in the calcium cycle plant, in which the gases are contacted with a solid stream having a high CaO content coming from a second fluidized bed reactor 64.

In said first reactor 60 which is called carbonator, the CaO contained in the solid stream 62 reacts with the CO₂ contained in the gas leaving filter 44 in accordance with the following reaction:

CO₂+CaO→CaCO₃

Said reaction is inverse to the calcination that is carried out in the cement plant In accordance with said reaction, the CO₂ contained in the gases is solidified by reacting with the CaO contained in the solid stream 62 and transformed into CaCO₃.

Said reaction is exothermic and occurs at a temperature between 600 and 700° C., preferably at 650° C. In order to control the operating temperature of said first reactor 60, it is necessary to continuously remove the heat produced by the above referred reaction by means of a water cooling system comprised by a plurality of coils 66 contacting the walls of the first reactor walls 60 or by any other suitable heat interchanging apparatus or method The reaction heat removed form said water cooling system is used to produce steam which alternatively may be used for moving an electric generator for producing electricity.

In such way, approximately, around 80% to 90% of the CO₂ produced in the cement plant is transformed in CaCO₃ and the remaining CO₂ exits the first reactor as a gas.

### Processing of the CaCO₃ for Obtaining the Captured CO₂

The gas and the solid exit the upper end of the first reactor 60 and are feed to a first cyclone 68 in which are separated The gas 70 exiting said first cyclone 68 having a low CO₂ content of between 1 to 8% and a temperature of between 600 and 700° C. is feed to a heat exchanger 72. The heat removed form said water cooling system is used to produce steam which alternatively may be used for moving an electricity generator to produce electricity.

The solid exiting from the first cyclone 74 comprising mainly CaCO₃, is feed to the lower end of a second fluidized bed reactor 64 in which it is carried out the CaCO₃ decarbonation in accordance with the following reaction:

CaCO₃→CaO+CO₂

The second reactor 64 is called decarbonator. The decarbonation reaction is an endothermic reaction which is carried out at a temperature of between 850 and 950° C., and therefore it is necessary to provide energy to said second reactor 64. Said energy is provided by the combustion of a fossil fuel or an alternative fuel in the form of a solid, liquid or gas 76 In order to avoid the introduction of nitrogen in the combustion gases, which will dilute the content of CO₂ in the gases exiting from the second reactor 64, the combustion for the second reactor 64 must be carried out with oxygen which is feed by a stream 77. The gases 78 exiting from the second reactor 64 contain a major part of the CO₂ produced by the cement plant and the CO₂ produced by the combustion carried out in the second reactor 64. Typically the CO₂ content in the gases 78 exiting from the second reactor 64 is of between 90 to 99%.

The stream 80 exiting the second reactor 64 is comprised by a gaseous stream containing mainly CO₂ and a solid stream containing mainly CaO. Said solid-gas mixture exits from the second reactor 64 by an upper end 80 thereof and it is feed to a second cyclone 82 in which the solid and the gas are separated: the gaseous stream 78, containing mainly CO₂ exiting the second reactor 64 at a temperature of between 850 and 950° C. and it is feed to a heat exchanger apparatus 84 in which its sensible heat may be alternatively used to produce steam for moving an electric generator.

The gaseous stream 78 exiting the second cyclone 84 has a CO₂ content from 90 to 99% (dry base) which may be sequestered by its injection in oil recuperation wells (enhanced oil recovery -EOR—) or by using any other sequestering technologies such as the injection of CO₂ in geological reserves located in the ocean as well as in the land. By such means, the cement plant CO₂ emissions are reduced by a 80% thus reducing the emissions of greenhouse gases.

### Cycling of Solids Products in the Calcium Cycle, Make Up and Purge of Calcium Cycle Main Reactive

The solids stream 62 exiting the second cyclone 82 comprising mainly CaO, is feed to the lower end of the first reactor 60 so it can react with the CO₂ contained in the gaseous stream 54 exiting the cement plant, thus closing a cycle.

The capacity of the CaO for reacting with the CO₂ contained in the cement plant combustion gas begins to drop when the number of carbonation/calcinations cycles carried out in the reactors 60 and 64 increases, that is, when parameters such as the quantity of CaCO₃ produced by the reaction drops below a predetermined parameter or when the temperature produced by said exothermic reaction begins to drop below 600° C. but preferably 650° C. In order to maintain the reactivity of the CaO flowing in the calcium cycle plant, to react with the CO₂, it is necessary to continuously feed said system with a fresh stream of CaO and to continuously purge from the system approximately the same amount of CaO to maintain the balance.

The CaO is purged from the second cyclone 82 exit line connecting the first reactor 60 and said second cyclone 82. Said purge contains mainly CaO comprising decarbonated limestone, which may be feed to a last stage cyclone 26 of the pre-heater 20 and rotary kiln 34 without the need of calcination thus increasing the productivity of the cement kiln and lowering its energy consumption. The CaO purge is feed to a heat exchanger apparatus 87 to recuperate its heat to produce steam for moving an electric generator.

In a first embodiment of the present invention shown in FIG. 1, the fresh CaO supply 88 is feed in the form of pulverized limestone, in which the CaCO₃ content is higher than a 95%. The limestone is feed to the second fluidized bed reactor 64 in which it is decarbonated together with the CaCO₃ coming from the first reactor 60. The solid stream exiting from the second cyclone 82 is comprised by the CaO produced by the calcinations of CaCO₃ coming from the first reactor 60 and the CaO produced by the calcinations of fresh limestone supply 88 feed to the second reactor 64.

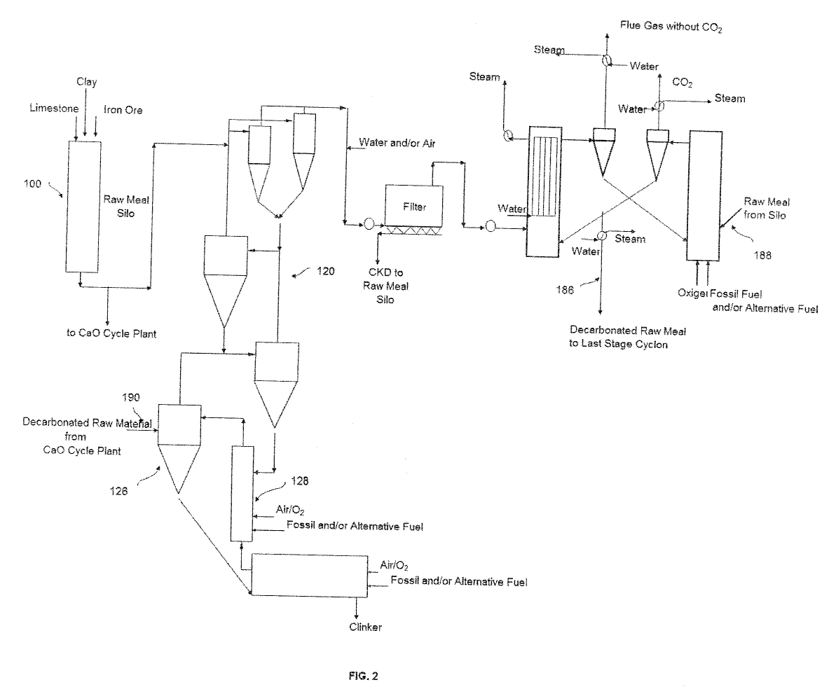

In a second embodiment of the present invention shown in FIG. 2, the fresh CaO supply 188 is comprised by raw meal directly taken from the cement plant silo 100. The raw meal CaCO₃ content is of approximately 75% which is lower than the limestone CaCO₃ content because the raw meal is comprised by a mixture of limestone, clay and iron ore. Due to its low CaCO₃ content, the amount of raw meal that must be fed is greater than the amount of limestone feed in accordance with the first embodiment of the invention. The advantage of feeding raw meal is that the purge stream 186 is comprised by solids having the same chemical composition as the calcined raw meal produced in the cement plant calciner 128, therefore said solids may be directly feed as a stream 190 to the last cyclone 126 of the pre-heater 120. The advantages of this second embodiment can only be seized when the calcium cycle plant is integrated to the cement plant.

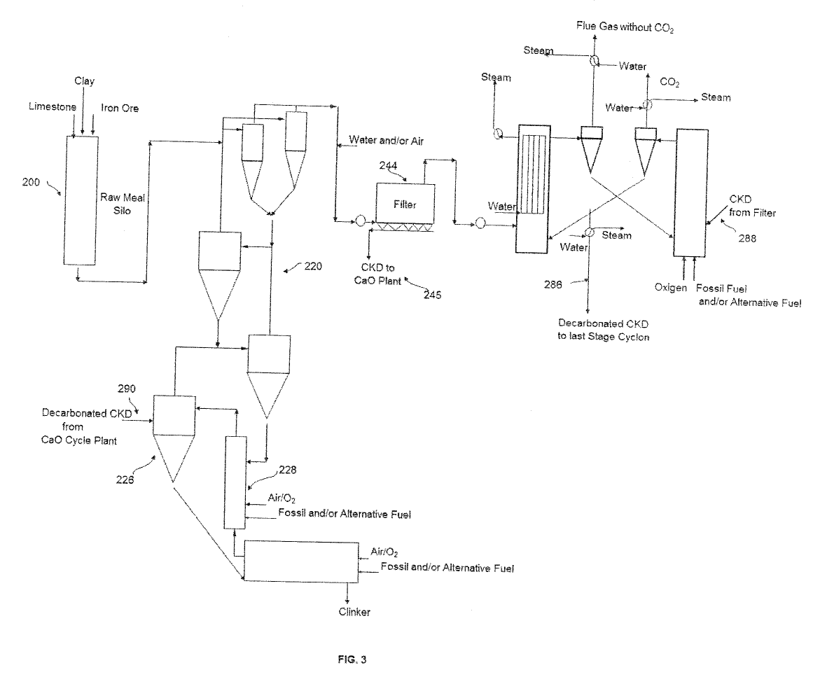

In a third embodiment of the present invention, shown in FIG. 3, the fresh CaO supply 288 is comprised by CKD directly taken from the stream 245 located at the exit of filter 244. The cement kiln dust is comprised by unreacted raw meal having a CaCO₃ content of approximately 75%. Due to the low CKD CaCO₃ content, the amount of the CKD that must be feed is greater that the amount of limestone feed in accordance with the first embodiment of the invention. The advantage of feeding CKD is that the purge stream 286 is comprised by solids having the same chemical composition as the calcined raw meal produced in the cement plant calciner 228. The advantages of this third embodiment can only be seized when the calcium cycle plant is integrated to the cement plant The amount of fresh CaO to be added in the form of pulverized limestone, raw meal or CKD depends on several factors such as the cement plant production, energy consumption of the cement plant, type of fuel used in the cement and calcium cycle plants, percentage of oxygen in excess present in the calciner, operational temperatures of both calcium cycle plant reactors and amount of CO₂ to be captured.

However, the amount of fresh CaO to be added continuously during a predetermined period of time may be quantified in an amount of preferably between 4 to 10% of the amount of raw meal feed to the pre-heater during said predetermined period of time. In the same way, the amount of CaO purged from the system during said predetermined period of time may be quantified in an amount of preferably between 2.0 to 10% of the amount of raw meal feed to the pre-heater during the same predetermined period of time.

The purge of pulverized CaO is used as raw material by feeding it directly to the last cyclone 226 of preheater 220 thru stream 290 thus increasing the productivity of the cement plant. Furthermore, by recuperating the heat produced in the first reactor, the heat from the gaseous streams leaving the two cyclones and the heat from the CaO purge stream, it is possible to generate the necessary electricity for covering the needs of the cement plant.

Finally it must be understood that the method for capturing CO₂ produced by cement plants by using the calcium cycle of the present invention, is not limited exclusively to the embodiments above described and illustrated and that the persons having ordinary skill in the art can, with the teaching provided by the invention, to make modifications to the method for capturing CO₂ produced by cement plants by using the calcium cycle of present invention, which will clearly be within of the true inventive concept and of the scope of the invention which is claimed in the following claims.

We claim:

1. A method for capturing CO₂ produced by cement plants by using the calcium cycle method wherein the cement is produced by the cement plant by the following method: grinding of raw materials comprising limestone, clay, and iron ore; homogenizing the raw materials in order to produce a raw meal; preheat the raw meal in the preheater section of a cement kiln in order to produce a preheated raw meal; calcining the preheated raw meal in the calcining section of the cement kiln in order to produce a calcined raw meal; feed said calcined raw meal into a rotary kiln in order to produce a clinker; cooling the clinker and feeding it to a mill in order to mix the clinker with gypsum and produce cement, wherein the cement kiln calciner section and rotary kiln produce combustion gases which are cooled and have a content of between a 15 to 30% of CO₂ and unreacted raw meal containing CaCO₃ which is filtered from the gas; and wherein the calcium cycle method comprise: contacting said combustion gases containing CO₂ with a solid stream having a high CaO content inside a first fluidized bed reactor in order to produce an exothermic reaction between the CO₂ and the CaO for producing a solid-gas mixture comprised by a CaCO₃ stream and a gaseous stream having a lower CO₂; content feeding said solid-gas stream to a cyclone for separating the solids from the gaseous stream and obtaining CaCO₃ solids and a hot gaseous having a lower CO₂ content; feeding the CaCO₃ solids into a second fluidized bed reactor to which it is provided heat by means of a combustion reaction, in order to decarbonate the CaCO₃ and produce a solid-gas mix comprised by a solid CaO stream and a gas stream comprised mainly by hot CO₂ coming from the gaseous stream leaving the cement plant and from the combustion reaction that provides heat to second fluidized bed; feeding the solid CaO stream and hot CO₂ stream into a second cyclone in order to separate the solids from the hot CO₂ and produce a hot CO₂ stream separated from a solid CaO stream; and recycling the CaO to the first fluidized bed reactor, wherein the method of the present invention comprise:
feeding the combustion gases produced by the calciner section and by the rotary kiln of the cement production plant to the first fluidized bed reactor of the calcium cycle method;
feeding the solid CaO stream separated by the second cyclone to the first fluidized bed reactor;
purging an amount of the CaO separated by the second cyclone when the capacity of the CaO to react with the CO₂ drops, and feeding it directly to the cement plant rotary kiln; and
making up fresh CaO to the second fluidized bed reactor of the calcium cycle method.

2. A method in accordance with the claim 1, in which the CaO is purged when the temperature produced by the exothermic reaction between CO₂ and CaO drops below 650° C.

3. A method in accordance with the claim 1, in which the make up of fresh CaO to the second fluidized bed comprises limestone.

4. A method in accordance with the claim 1, in which the make up of fresh CaO to the second fluidized bed comprises raw meal taken directly from a cement plant silo.

5. A method in accordance with the claim 1, in which the make up of fresh CaO to the second fluidized bed comprises unreacted raw mill filtered from the combustion gases produced by the cement plant.

6. A method in accordance with the claim 1, in which the fresh CaO is continuously added to the second fluidized bed and wherein the amount of fresh CaO added during a predetermined period of time is between 4 to 10% of the amount of raw meal feed to the pre-heater during said predetermined period of time.

7. A method in accordance with the claim 1, in which the CaO separated by the second cyclone when the capacity of the CaO to react with the CO₂ drops is continuously purged and wherein the amount of CaO purged during a predetermined period of time is between 2 to 10% of the amount of raw meal feed to the pre-heater during said predetermined period of time.

8. A method in accordance with the claim 1, in which the heat recuperated from the first fluidized bed reactor, from the hot gases from the two cyclones and from the CaO purge stream in the calcium cycle method is used for producing steam for moving an electric generator and producing electricity which is used for covering the needs of the cement plant.

9. A method in accordance with claim 1, in which the CO₂ stream exiting the second cyclone is sequestered by its injection in wells for the enhanced oil recovery.

10. A method in accordance with claim 1, in which the CO₂ stream exiting the second cyclone is sequestered by its injection in subterranean geological reserves in the ocean as well as in land.
